(19) United States
(12) Patent Application Publication
(10) Pub. No.: US 2017/0193477 A1
(43) Pub. Date: Jul. 6, 2017

(54) BILL PAYMENT INFRASTRUCTURE FOR BILL SPLITTEES

(71) Applicant: BillGO, Inc., Fort Collins, CO (US)

(72) Inventors: Daniel W. Holt, Steamboat Springs, CO (US); Kelly Lynn Seidi, Fort Collins, CO (US); Scott M. Miller, Warsaw, IN (US)

(73) Assignee: BillHero, Inc., Fort Collins, CO (US)

(21) Appl. No.: 15/359,604

(22) Filed: Nov. 22, 2016

Related U.S. Application Data
(60) Provisional application No. 62/258,843, filed on Nov. 23, 2015.

(51) Int. Cl. G06Q 20/14; G06Q 20/22

(52) U.S. Cl. CPC G06Q 20/14; G06Q 20/29; G06Q 20/227

(57) ABSTRACT

Described herein are technologies to facilitate a bill-payment infrastructure that offers a two-part mechanism for multiple parties (herein, “splittees”) to pay their portion of an outstanding invoice/bill. One part of the mechanism handles the accounting, tracking, and notification of each splittee's portion (e.g., how much is owed and whether it was paid in full and on-time). The second part of the mechanism handles the actual bill payment from each splittee.

### BACKGROUND

Modern life comes with expenses. Indeed, some of these expenses are often tied to living arrangements. That is, a person is obligated (i.e., financially responsible) to pay expenses based upon their living arrangement (i.e., household). Examples of household expenses include regular (e.g., monthly) payments for the shelter/property (e.g., rent/mortgage); maintenance/upkeep for shelter/property (e.g., resident association dues; exterior maintenance fees; lawn care services; etc.); utilities (e.g., water, gas, electric, garbage pick-up, sewer, etc.); communications (e.g., cable/satellite television, broadband internet connections, telephone, etc.), insurance, and the like. Other living-arrangement expenses may be one-time or infrequent expenses related to a household. For example, a residence may need a repair or remodeling. The related expenses are household expenses. Herein, these household expenses are called household “bills.”

More generally, any expense or invoice for which multiple parties have a financial obligation to pay is called a “bill” herein. The multiple parties (e.g., humans, businesses, etc.) that share that financial obligation are called “splittees” herein. For context, the discussion herein focuses on housing and living arrangements as merely an example of a typical bill (e.g., rent) shared by splittees.

There are many different possible living arrangements. Some people may live alone. In that situation, then that sole occupant is typically exclusively obligated for the expenses of that household. Some people can live in an institutional arrangement. For example, a nursing home or military barracks are forms of institutional households. In that situation, the living-arrangement expenses are the obligation of another party (e.g., government, military, etc.) who is typically not a resident or even a human.

Often people live collectively in one residence or house. It is common for a family to live collectively but with one or two people in that family carrying the financial burden for the expenses of the entire household. Herein, this arrangement is called a familial household (regardless of whether any actual family relationship exists amongst the residents). In this arrangement, only a select few (one or two) of the residents are financially responsible and obligated for all of the household expenses. For example, the adult parents (e.g., mother and father) are responsible for the household expenses of all residents—including their children and adult relatives living in the home.

In contrast with a familial household is a “roommate” or “share-expenses” living arrangement. Generally, a roommate is someone sharing the same apartment, house, or another dwelling with another. More particularly for the purposes herein, roommates are common dwelling occupants that also share the household living expenses.

As of recently, the trend in the U.S. is towards more and more adults living with a roommate and doing so for longer than before. Currently, over ninety million (90,000,000) adults live in a shared living situation in the U.S. Thus, the trend is towards more and more roommate households.

FIG. 1 illustrates a typical arrangement 100 where multiple roommates share a common bill (e.g., rent). The arrangement 100 includes a roommate household 110 that includes three roommates 112, 114, 116. Roommate 112 is the primary or visible roommate. The arrangement 100 also includes a single biller 160 for a particular bill (e.g., rent, utilities, etc.).

Unlike the familial household, each of the residents in the roommate household 110 is responsible for at least some portion of household expenses (e.g., rent). While each roommate may be responsible for a portion of household bills, the logistics of meeting those obligations are burdensome at best. Typically, bill creditors (e.g., biller 160) are not equipped to handle payments from multiple parties for one bill. Often, the bill creditor is not interested in tracking such payments. Herein, a bill creditor may also be called a “biller” or “payee.” Landlord 162 is a particular example of a biller 160.

Because of this, the burden of paying bills often falls onto one of the roommates. In this scenario, the visible roommate 112 manually pays the outstanding bill but seeks to get repaid by the other roommates for their portions. Payment arrows 124 and 126 represent payments from other roommates 114, 116 to the visible roommate 112. Payment arrow 122 represents the visible roommate issuing a single collective payment to the biller 160 for the bill. That payment is often in the form of a written paper check 152 that is mailed via the postal service.

In the rare occupation when the biller accommodates payments from multiple parties for an outstanding bill, the other roommates do not know whether their roommates actually paid their portion of the bill. That means that the roommates are not aware of whether the entire bill was paid or whether it was paid in a timely fashion.

Typically, the bill is in the name of primary roommate (i.e., the visible roommate 112). When one or more of his roommates 114, 116 fail to pay their portion of the outstanding bill, then visible roommate 112 is burdened with the repercussions of an unpaid bill. That may include negotiations with the bill creditor, bill collectors, and/or credit record damage.

Right now, these manual roommate payment situations are handled, for example, via sticky note reminders and spreadsheet calculations. Many different miscellaneous applications to try to help the roommates with the calculations and then each roommate writes checks to pay their portion of the bill. There is no good way for them to split and pay their bills today, and it causes a lot of problems with the roommates, related to relationships.

A lot of bills, and especially rent, are actually still paid by paper checks. With the conventional approach, someone has to track where the landlord lives, gather the checks from each roommate (or cover for the other roommates), buy stamps, and mail the checks. A typical roommate is young and often doesn't have or doesn't use checks. All payments are typically online or via mobile payments.

A joint account is one existing approach available to roommates who want to pay a roommate household bill with a single payment (e.g., check) to the biller. Unfortunately, this requires a degree of trust that is not often found and may not be desirable in a roommate situation. A joint account necessarily requires the co-mingling of funds from at least two different people. At worse, this leaves one person's funds venerable and exposed to the other. That is, one roommate may drain the entire amount without sufficient safeguards in place.

At best, with proper safeguards, this arrangement makes it more difficult for a roommate to access her own funds from the account. For example, one roommate must wait to get the signature of their joint account holder before a bill can be paid.

Regardless, such a joint account quickly turns into an accounting nightmare. For example, who determines how much of the remaining funds in the joint account belongs to which roommate? How is the determination made? Who balances the checkbook?

In general, the joint account approach is a highly impractical approach for the traditional roommate situation. It causes undesirable financial and legal entanglements amongst roommates, who might not know each other well or at all.

### BRIEF DESCRIPTION OF THE DRAWINGS

FIG. 1 illustrates a conventional approach to an arrangement for paying a bill where multiple parties share the financial obligation.

FIG. 2 illustrates an example bill-payment infrastructure in accordance with the technology described herein.

FIGS. 3A and 3B illustrate screenshots of a user interface of an example bill-payment infrastructure in accordance with the technology described herein.

FIG. 4 illustrates another example bill-payment infrastructure in accordance with the technology described herein.

FIGS. 5 and 6 are flowcharts of methodological implementations of the technology in accordance with implementations described herein.

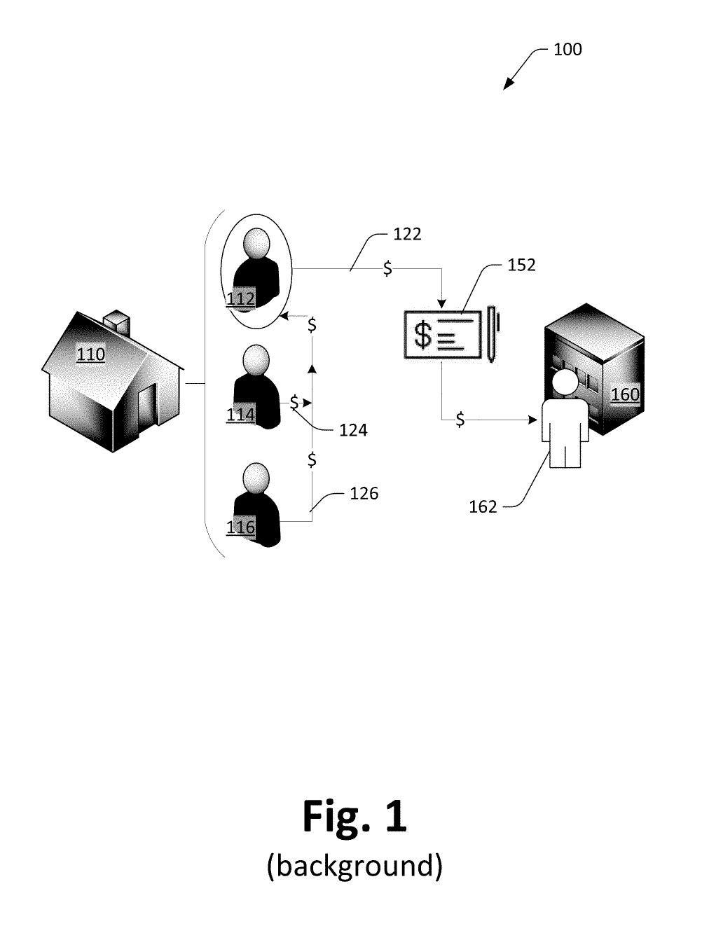

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein are technologies to facilitate a bill-payment infrastructure that offers a two-part mechanism for multiple parties (herein, “splittees”) to pay their portion of an outstanding invoice/bill. One part of the mechanism handles the accounting, tracking, and notification of each splittee's portion (e.g., how much is owed and whether it was paid in full and on-time). The second part of the mechanism handles the actual bill payment from each splittee.

For a single bill, the bill-payment infrastructure—in accordance with one or more embodiments described herein—gathers assigned portions of the owed amount of the bill from the splittees. From the collected multiple payments from the splittees, the infrastructure sends a single payment to the invoicing party (“biller”). If possible, the infrastructure of one or more embodiments sends payment via an existing electronic bill-paying network. If not possible, then the infrastructure of one or more embodiments sends a traditional paper check via a postal, courier, or package delivery service. Regardless, the biller receives a single payment for its bill/invoice.

With one or more implementations described herein, a splittee pays their portion of the bill from one or more different funding sources (e.g., checking account, savings account, credit card account, line-of-credit, etc.). The bill-payment infrastructure—in accordance with one or more embodiments described herein—does not care which or how many different funding sources are used to pay a portion of a bill. Thus, it is agnostic regarding funding sources.

In addition to the funding source, the splittee chooses the manner that the moneys are transferred from the funding source to pay the bill with one or more of the described embodiments. These are called funding transactions (e.g., electronic funds transfer (ACH), physical checks, debit card transaction, credit card transaction, etc.) The bill-payment infrastructure—in accordance with one or more embodiments described herein—does not care which type of different funding transaction that is used to pay a portion of a bill. Thus, it is agnostic regarding funding transaction.

There may be times, when a bill comes due, that all of the necessary funds to pay a splittee's portion of the bill are not gathered into one funding source (e.g., checking account). With traditional approaches to paying bills, the billers and bill-paying networks are not equipped to handle multiple payments from multiple different sources and/or using multiple different transaction types. With the new bill-payment infrastructure—in accordance with one or more embodiments described herein, the splittee has the option to pay their portion from multiple differing funding transactions/sources. In that situation, the bill-payment infrastructure aggregates moneys paid various different ways and from different splittees into a single bill payment. With one or more described implementation, the biller receives and the bill-paying network sends only one aggregated payment.

With one more of the described embodiments, a splittee is given notifications of when their portion of a bill payment must be funded. The timing of these notifications takes into account the latency of a cascade of funding events (e.g., funding from one or more of the splittee's sources; confirmation time for ACH; funding to intermediary electronic payment services; etc.). In one or more implementations, fellow splittees are notified when there is a funding shortage for a looming bill payment. They are given options to handle the funding shortfall situation (e.g., handle socially, provide additional funding, etc.).

With one or more of the described embodiments, a group of splittees is assigned to a group called a “household group,” a “shared-responsibility group” or more simply a “group.” Depending upon the embodiment, this assignment may be assigned manually, automatically, or semi-automatically. With one or more embodiments, the group assignment comes a set of defaults for all bills associated with the address of the group, such as default splits.

With one or more of the described embodiments, a set of priorities/preferences (i.e., waterfall) may be assigned for fund sources and funding transactions from which payments may be made. For example, given particular conditions (i.e., funding availability, the timing of payment, etc.), a splittee's portion of a bill payment may be pulled from particular fund sources using particular funding transaction types.

### Example Bill-Payment Infrastructures

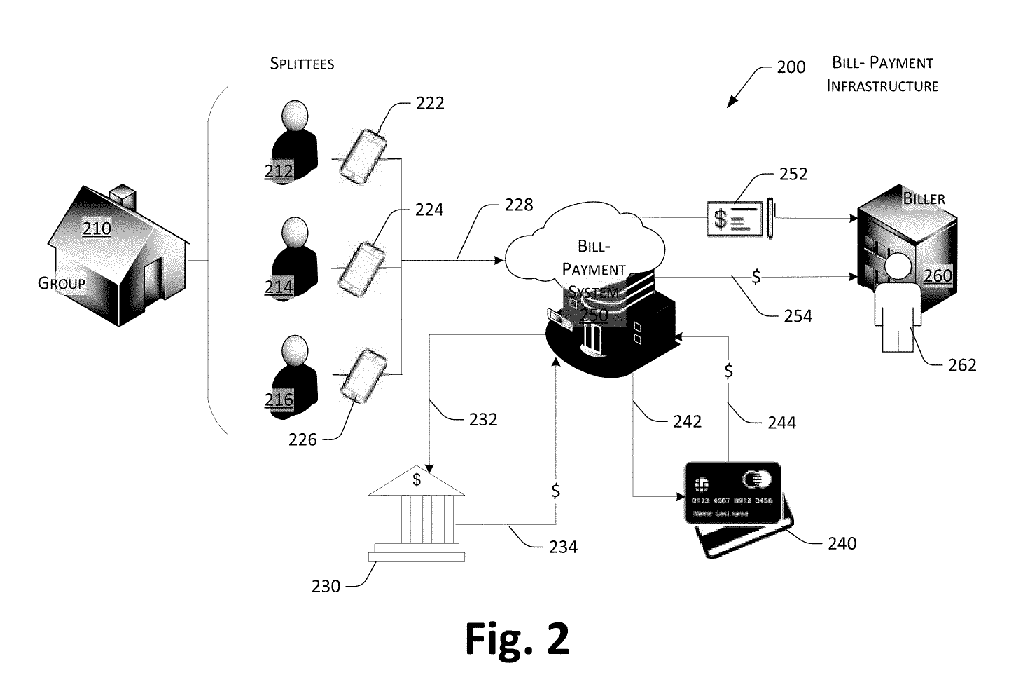

FIG. 2 shows an example bill-payment infrastructure 200 in accordance with one or more implementations described herein. The example bill-payment infrastructure 200 includes a group (“household”) 210 of splittees 212, 214, 216; bill-payment system 250; and the biller 260.

For this discussion of this example bill-payment infrastructure 200, presume there is an invoice or bill (herein, after “bill”) for which all of the splittees 212, 214, 216 share some portion of financial responsivity. If this scenario is involved home lease, then the three splittees are roommates. And each splittee is responsible for some portion (e.g., equal portion) of the monthly lease payment (‘rent”). In the lease scenario, the biller 260 includes a landlord 262.

For this example bill-payment infrastructure 200, the group 210 includes three splittees 212, 214, 216. Rather than one splittee gathering all of the payments from her fellow splittees (as is the case with the conventional approach to bill paying with multiple responsible parties), each splittee is responsible for direct payment of their portion of the bill/invoice.

To pay the bill/invoice, a splittee uses a customized mobile application (herein, “app”) on their mobile device. Examples of such a mobile device include a smartphone, a tablet computer, a laptop computer, a smart watch, a smart wearable device, a personal assistance device (PAD), and the like. As depicted, each splittee uses a corresponding smartphone 222, 224, 226.

The app is part of the client-side of the example bill-payment infrastructure 200. The client-side is offered online via a web browser or application running on a so-called desktop computer (e.g., PC running Windows™ or a Mac™ running a MacOS™.) The client-side of the Service is also offered via the app or a web browser on a mobile device. For example, it may be an app on a smartphone (such as phone that is Android™ or iOS™ based).

To use the bill-payment infrastructure, usually one of the splittees of the group 210 initiates an account and associates it with that group (e.g., household). This splittee is called the lead splittee herein. The other splittees of that group are invited to join the associated account.

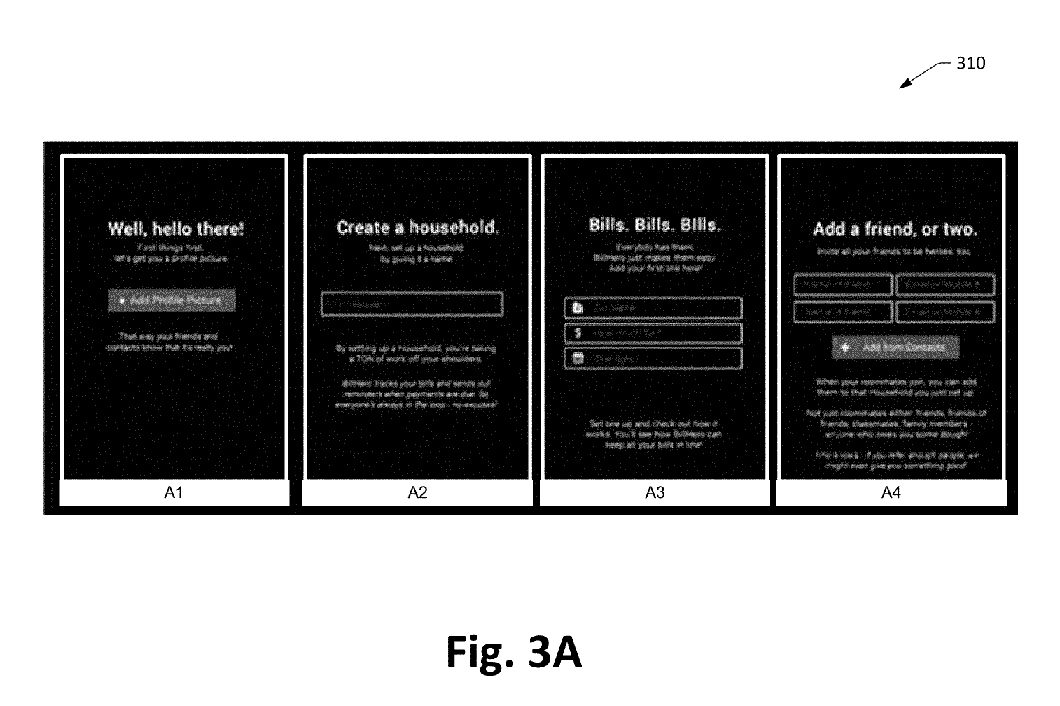

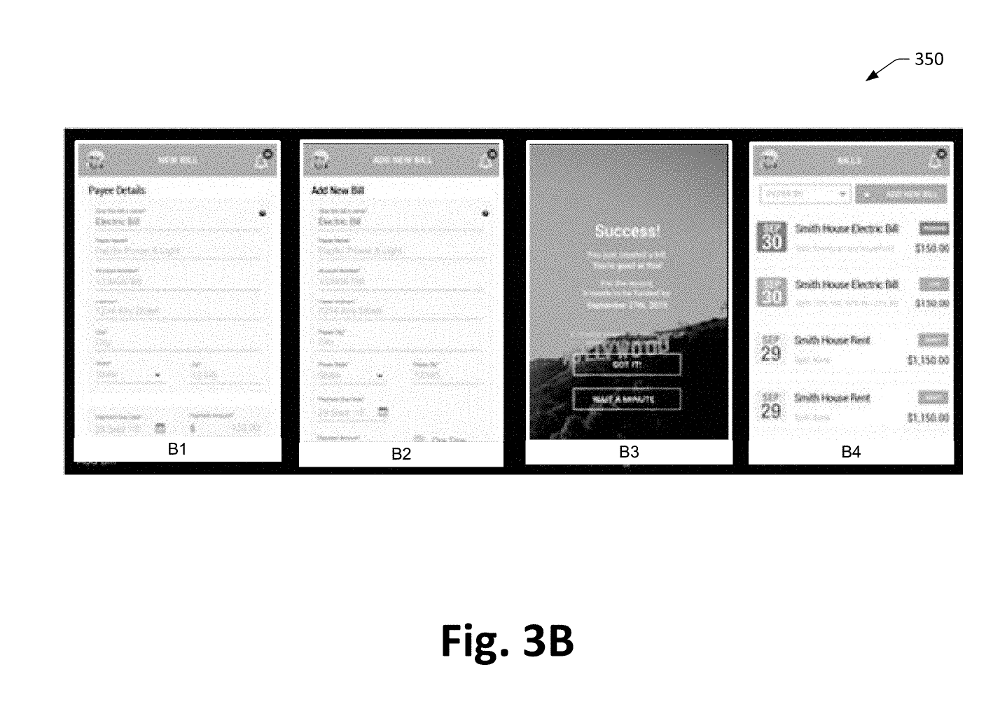

FIG. 3A shows a set 310 of four example screenshots of an app that acts as a client interface to the example bill-payment infrastructure 200. Likewise, FIG. 3A shows another set 350 of four example screenshots of the app. The screenshots of the set 310 are labeled A1-A4 from left to right. For example, screenshot A3 is the third screenshot from the left of set 310. The screenshots of the set 350 are labeled B1-B4 from left to right.

As shown in screenshot A2, a new user typically establishes a “household,” which is a label for this type of group A household is given a name, default splittees (e.g., roommates), default splits, and a listing of bills and their associated details. Screenshot A3 shows an example of the screen for entering bill information.

One of the splittees—who is called the “bill owner” herein—defines a new bill (e.g., rent, utilities, etc.). As illustrated in set 350, the bill owner provides the identification of the biller, the amount of the debt associated with the bill, and a date that the debt is due. They may also provide the name of the biller, the biller's account, the biller's address (and perhaps other contact info like email address).

In the real world, each bill is typically associated with a particular person. For example, when a person sets up trash pick-up for a house, there is only one person who calls and do that, regardless of how many people are living in the house. So, there is one person's name that's on that bill, and it's one person's credit that is attached to that. So, if they have a bad credit score, the trash company charges them an extra deposit. If they don't make payments, it's their credit score that gets affected. It's one legal entity (e.g., person) who is responsible for that bill at the end of the day. There is a real world responsibility implication of not paying a bill. As much as roommates say that they share the responsibility equally, ultimately the bill owner is the legal entity that has the burden and consequences for non-payment of that bill.

With the example bill-payment infrastructure 200, it is anticipated that the bill owner is this legal entity that is solely or primarily responsible for that particular bill.

The bill owner can edit multiple options related to the bill. For example, the bill owner can change the splittees for the bill (e.g., more or less than all of the roommates of the household group). The bill owner can change the allocation of the split for the bill. In those situations, the new splittee is asked to approve their new responsibility in the bill.

When a bill is first created, nothing is finalized yet. The bill owner assigns a split allocation (e.g., 25% for each of 4 roommates). Each splittee receives a notification. It asks the splittee to approve the details of the new responsibility of a bill. The other splittees can approve or decline their responsibility. If they all approve, then the bill is finalized. If not, then the bill owner is notified accordingly. Thus, the bill owner is likely to have to negotiate an acceptable split allocation with the declining parties.

The bill owner can specify the percentages for all the splittees. The splits can be pretty complex. Straight percentages are not always sufficient. Sometimes there is a handshake deal to the effect: “hey, you got the master bathroom you're going to pay $700 of the rent, and I'm going to pay $500.” So, in addition to using percentages for split allocation, the example bill-payment infrastructure 200 also allows explicit amounts. Indeed, the bill-payment infrastructure may allow for conditional split allocations. For example, consider roommate A paid more (e.g., $100) than their typical share of the rent on the 1st of the month to make up for roommate B's shortfall. Then, on the 15th of the month, when the utilities come due, roommate B is conditionally determined to owe more (e.g., $100) for that bill and roommate A owes less.

Upon setup, the bill owner specifies the regularity of the bill (e.g., monthly). That is, when will the bill come due (e.g., the 14th of each month). The owner also specifies how much the bill is—presuming that it is fixed (e.g., rent). In the case of variable bills, the bill owner is prompted to provide the bill amount each billing period.

Alternatively, the bill-payment infrastructure may acquire and/or check this bill information automatically or semi-automatically. For example, the example bill-payment infrastructure 200 may query the biller for bill information (e.g., fixed or variable amount) for the particular bill. In another example, the bill-payment infrastructure may access the bill owner's (and/or splittees) financial accounts to determine the history of payment of that particular bill.

Some implementations may utilize technology integration with particular billers (e.g., utility companies, cellular phone services, etc.). With such integration, the billers provide the particular bill information (e.g., amount, due date) to the example bill-payment infrastructure 200.

In other implementations, the users (e.g., splittees) may provide permission to access various and different online financial accounts (e.g., bank accounts, credit cards, etc.) to gather relevant data regarding the user. In this instance, it will determine/verify bill details based upon the history of payments for that particular bill.

With the example bill-payment infrastructure 200, the splittees need not form a joint account to pay bills of the group with a single payment (e.g., check) to the biller. Therefore, they do not need to form the financial and legal entanglement of a joint account to pay roommate bills with a single payment (as a biller typically prefers). Indeed, with the example bill-payment infrastructure 200, each roommate pays their portion of the bill without any need to co-mingle their moneys with another roommate and subject their moneys to financial risk and accounting nightmares of a joint account.

Using the app or website, the splittee chooses to pay their portion (i.e., “split”) of the bill/invoice. The splittee selects the source of the funding and the transaction type. For example, splittee 214 may use the app on the smartphone 224 to pay her split (e.g., $100) of the rent. In doing so, the splittee 214 chooses her checking account at her bank. Alternatively or in addition, the splittee 214 may choose to use funds from one of her credit cards.

The app on each of the mobile devices generate the instructions that correspond to the direction of their splittees. Arrow 228 represents the delivery of those instructions to the bill-payment system 250. For illustration purposes, only one arrow 228 is shown but it represents multiple separate communications from the various mobile devices used by the splittees.

Once the bill-payment system 250 receives the instructions from a splittee, the system acts on those instructions accordingly. Based upon instructions to fund from a checking account at bank 230, the system 250 communicates 232 with the bank and electronically receives funds 234 from that bank. Similarly, based upon instructions to fund from a credit card account at credit card company 240, the system 250 communicates 242 with the company and electronically receives funds 244 from that company.

Once there are sufficient moneys to fund a full payment of the bill/invoice to the biller 260, the bill-payment system 250 sends the payment. If the biller 260 is capable of receiving electronic payment, then the system 250 directs an electronic transfer 254 of funds to the biller. Otherwise, the system 250 directs the production and sending of a paper check 252 to the biller 260. With the example bill-payment infrastructure 200, the biller receives a single payment (e.g., one check or single electronic transfer) from the multiple payments/splittees.

For the sake of simplicity, the biller 260 is described as part of the example bill-payment infrastructure 200. Alternatively, the biller 260 may be considered to be outside the example infrastructure since it receives the output (e.g., payment) from the bill-payment system 250.

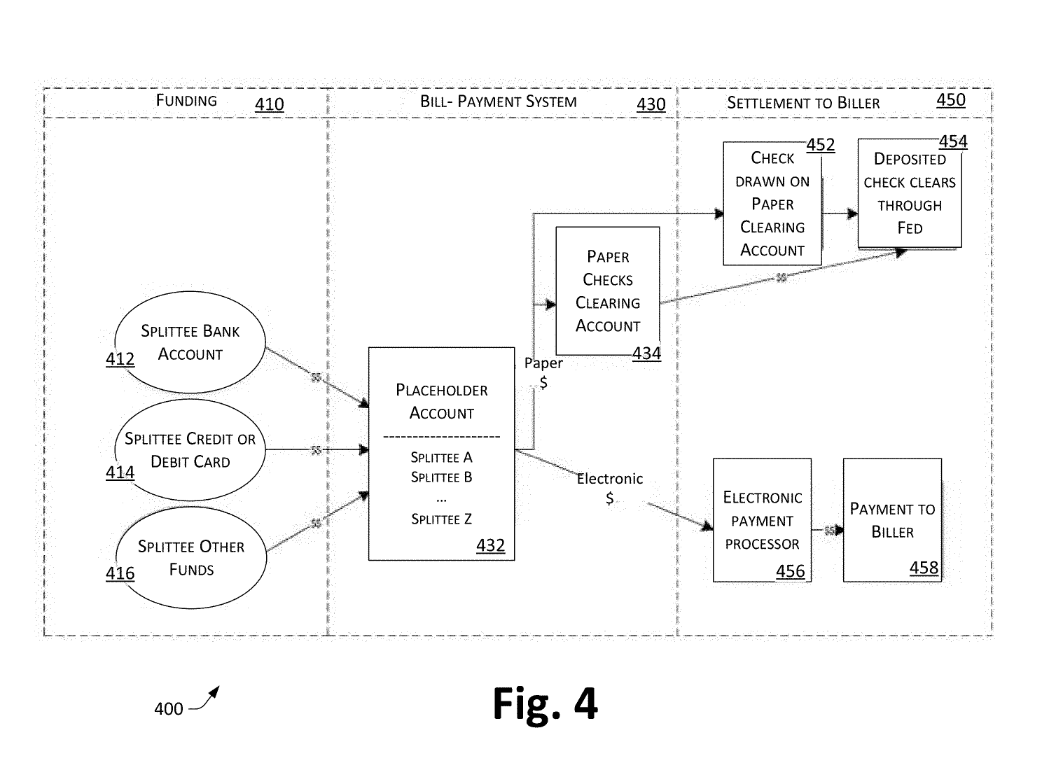

FIG. 4 shows an overview of another example bill-payment infrastructure 400 in accordance with one or more implementations described herein. The example bill-payment infrastructure 400 includes three sections. From left to right, those sections are Funding 410, Bill-Payment System 430, and Settlement to Biller 450. These sections represent the flow of moneys for bill-payment for the example bill-payment infrastructure.

The funding section 410 includes a listing of three different representative funding sources/transactions 412, 414, 416. In at least one implementation, the bill-payment infrastructure performs a just-in-time pull transaction rather than a push transaction for these funds.

In a push transaction, the moneys are transferred to a separate account and it awaits its ultimate destination (such as paying a biller). In this situation, the user has less liquidity because some of her moneys are sitting in a separate account awaiting action. Often, the user cannot access or has limited access to this separate account for any purpose other than those allowed by the separate account.

However, in a pull model (like that of the example bill-payment infrastructure 400), the moneys are pulled from the user's account(s) just in time when needed to pay a looming bill. In this way, the user (e.g., splittee) has maximum liquidity of their moneys.

The first funding source/transaction 412 represents a user's (e.g., splittee) bank account being a funding source and an electronic transfer (e.g., ACH) being used to transfer the moneys from that funding source to a placeholder account 432 of the bill-payment system 430. Typically, an ACH transaction takes 3-4 days. That is, it takes 3-4 days from the request of the moneys from the funding account for the moneys to arrive in the placeholder account 432. That is the industry standard transaction time for an ACH type transaction.

The second representative funding source/transaction 414 represents a user's (e.g., splittee) credit-card or debit-card transaction via a merchant processor. This transfers the moneys from that funding source (e.g., credit from the credit card company or the checking account for the debit card) to the placeholder account 432 of the bill-payment system 430. This transaction takes place right away. That is, the moneys are transferred to the placeholder account as soon as the instructions to do so are received and verified. Typically, the transfer time is measured in seconds or perhaps as long as minutes.

The third representative funding source/transaction 416 represents a user (e.g., splittee) having some type of non-bank funding source (e.g., VENMO®, PAYPAL®, etc.) as a funding source and an electronic transfer from that source to the placeholder account 432 of the bill-payment system 430. Unlike a traditional ACH transfer, these transfers typically occur right away. That is, the moneys are transferred to the placeholder account as soon as the instructions to do so are received and verified. Typically, the transfer time is measured in seconds or perhaps as long as minutes.

The bill-payment system 430 includes the placeholder account 432 and a paper check clearing account 434. The placeholder account 432 includes all of the moneys in the midst of transit from the users to the payees and/or moneys being held in anticipation of forthcoming transactions. The paper check clearing account 434 is the logical unit that cuts and sends the physical checks to the payees that cannot or will not accept electronic payments.

With the example bill-payment infrastructure 400, there is never a bounced check or overdraft situation. The bill-payment system 430 verifies that it has acquired sufficient funds from the splittees before issuing a payment. With conventional payment models, a user may write a check with anticipation of funds being in the account when the check is cashed. However, intervening events may drain the account before the check is cashed. This causes an overdraft to the account or a bounced check.

The example bill-payment infrastructure 400 ensures that there are sufficient moneys available before such moneys are pulled into the placeholder account 432 of the bill-payment system 430. The bill-payment infrastructure directly associates the moneys that were moved into the placeholder account 432 of the bill-payment system 430 to pay a particular biller. For example, the State University Residence Hall (SURH) may be the particular biller that is associated with a particular bill (e.g., October rent). That money remains available in the placeholder account 432 of the bill-payment system 430 until the biller is paid for that bill (e.g., via electronic payment or paper check is cashed). With the example bill-payment infrastructure 400, the user has no fear of overdrawn accounts or bounced checks.

The settlement to payee section 450 includes a representation 452 of the physical checks being mailed via US Postal Service (for example) and a representation 454 of a landlord/biller depositing the received check at their bank. The check may be drawn on the paper check clearing account 434.

In addition, the settlement to payee section 450 includes a representation 456 of an electronic payment processor of a bill-paying network performing its electronic payment processing and a representation 458 of the electronic payment actually being sent the biller and deposited into their account.

The biller's information is used by the bill-paying network. The example bill-payment infrastructure 400 may offer its own or may partner with an existing bill-paying network. The bill-paying network (e.g., Allied Payment Network—www.alliedpayment.com) is a company that typically works with major banks and billers. It manages a database of billers that can be paid from accounts hosted by affiliated banks.

With the bill-paying network, it is not necessary to know the billers' bank account number, the bank routing number, and the like. Typically, the biller is identified by its phone number and the company name.

If the biller is part of the bill-paying network, then it receives a payment in the method that the biller designated for doing so. Typically, that will be an electronic transfer of funds to the biller's bank account. If the biller is not part of the network, then a traditional paper check is mailed to the biller via the postal service or some other delivery service. When such a payment arrives, the biller is notified of how to join the bill-paying network. In that way, the biller can receive payment quicker via electronic payment.

### Universal Bill-Payment Infrastructure

Some implementations of the technology described herein may be called “universal.” This descriptor of the bill-payment infrastructure refers to the fact that any biller can be paid with this bill-payment infrastructure. In other conventional bill-paying options, the biller must be integrated or has a pre-existing relationship with the bill-payment service. Because of that, the bill payer (e.g., splittees) are unable to pay bills for billers that do not have that integrated/pre-existing relationship with the conventional bill-payment service.

With the example bill-payment infrastructure 400, the biller need not have a pre-existing or integrated relationship with the bill-payment infrastructure. Indeed, the biller need not even have a relationship with a bill-paying network or have a credit card merchant account. Rather, the biller just needs to be able to receive payment via existing known means, such as electronic transfer or paper checks via delivery.

Also, in part, the “universal” descriptor refers to the fact that the splittee can pay their portion of a bill from virtually any funding source and any available funding transaction.

The example bill-payment infrastructure 400 has one or more of its own central accounts (e.g., account 432). While there may be multiple “central” accounts managed by the bill-payment infrastructure 400, it will be referred to a single central account (e.g., account 432) for simplicity sake. This central account may be with a bank or the bill-payment infrastructure 400 may act as its own bank. The central account is an aggregate of all received moneys.

One of the mechanisms for the “universal” aspect of the example bill-payment infrastructure 400 is the use of a central account. In a sense, with its central account, the example bill-payment infrastructure 400 acts in a manner akin to a “clearinghouse” between the splittees and the billers.

Each splittee of each bill pays their portion into that central account (e.g., account 432) from one or more of the splittee's funding sources/transactions. Once all of the payments/portions of an outstanding bill have been received in the bill-payment infrastructure's central account, a single payment covering the outstanding debt (i.e., amount owed on the bill) is sent to the biller. At least in part, the example bill-payment infrastructure 400 is universal because the splittee can make payments from any funding source and via any available funding transaction. The bill-payment infrastructure is universal because the biller receives a single payment (which is highly desired by nearly all billers) for each outstanding bill.

The example bill-payment infrastructure 400 offers peer to peer (P to P) or peer to business (P to B) transactions for splittees of a group to pay a bill. If that bill is from a person (e.g., a landlord), then the transaction is P to P. If that bill is from a company (e.g., utility), then the transaction is P to B.

### Funding Source and Transaction Agnostic

With the example bill-payment infrastructure 400, the splittee pays their portion of the bill from one or more different funding sources (e.g., checking account, savings account, credit card account, line-of-credit, etc.). The example bill-payment infrastructure 400 does not care which or how many different funding sources are used to pay a portion of a bill. Thus, it is agnostic regarding funding sources. In addition to the funding source, the splittee chooses the manner that the moneys are transferred from the funding source to the biller. These are called funding transactions (e.g., electronic funds transfer (ACH), physical checks, debit card transaction, credit card transaction, etc.) The example bill-payment infrastructure 400 does not care which type of different funding transaction that is used to pay a portion of a bill. Thus, it is agnostic regarding funding transaction.

As the name implies, a funding source is a financial account from which the moneys are drawn. That is, they are the actual or literal source of the moneys. Typically, these sources are either credit accounts (e.g., a checking or savings account at a bank) or debit accounts (e.g., a credit card or line-of-credit (LOC) from a financial institution). The owner (or one of the responsible parties) of the funding sources may be the splittee or her sponsor. Each of these actual funding sources may be affiliated or hosted by unrelated financial institutions. For example, one funding source may be the splittee's checking account at Grand National Bank while another funding source may be the splittee's credit card offered by Intergalactic Federation Bank. In this example, we presume that these banks are not affiliated in any way.

A funding transaction is a manner in which moneys are transferred from the splittee's funding source(s) to the biller. Those funding transactions may be, for example: electronic bank transfers (ACH); paper/physical check delivery; debit card transactions; credit card transactions, and the like. Each of these funding transactions may draw the actual funds from differing types of actual funding sources.

The most common/popular form of electronic funds transfer in the United States is called Automated Clearing House (ACH). It is an electronic network for financial transactions in the United States. ACH processes large volumes of credit and debit transactions in batches. ACH credit transfers include direct deposit, payroll and vendor payments. ACH direct debit transfers include consumer payments on insurance premiums, mortgage loans, and other kinds of bills. Debit transfers also include new applications such as the point-of-purchase (POP) check conversion pilot program sponsored by NACHA (nacha.org/ach-network). Both the government and the commercial sectors use ACH payments. Businesses increasingly use ACH online to have customers pay, rather than via credit or debit cards.

ACH is a computer-based clearing and settlement facility established to process the exchange of electronic transactions among participating depository institutions. In short, ACH is a bank to bank transfer. With ACH, funds are transferred from a source bank account to a destination bank account. The transfer goes through ACH.

Unlike a credit card or debit card transaction, there is no balance query. So ACH is a blind transaction. There is no guarantee of funds availability. Typically, one must wait three business days until it is known that those funds won't be redacted out of the account.

### Allocation of Moneys for Payment

There may be times, when a bill comes due, that all of the necessary funds to pay a splittee's portion of the bill are not found in one funding source (e.g., checking account). With traditional approaches to paying bills, the billers and bill-paying networks are not equipped to handle multiple payments from multiple different sources and/or using multiple different transaction types.

However, with the example bill-payment infrastructure 400 described herein, the splittee may pay their portion from multiple differing funding transactions/sources. The example bill-payment infrastructure 400 aggregates moneys paid various different ways and from different splittees into a single bill payment. The biller receives and the bill-paying network sends only one aggregated payment.

For illustration purpose, consider this example:

Roommates: Isabel and Hope

Bill: Rent for $1000

Split: each pays half

Hope has these available funding sources:
First Town Bank Checking (balance: $200)
First Town Bank Savings (balance: $160)
Branded Credit Card (available: $350)

Hope's allocation to pay her $500 portion of rent:
$100 from checking (using ACH transaction)
$100 from savings (using ACH transaction)
$300 from credit card

Based upon the above example, Hope pays her $500 portion of the rent using three different sources (with their appropriate transaction type). So, not only is the rent being paid by two different parties (i.e., splittees), at one of those parties is paying their portion from different sources/transactions. Indeed, each splittee picks their own allocation.

In some implementations, the example bill-payment infrastructure 400 may automatically (or semi-automatically) pick the appropriate allocation for a splittee. Herein, “semi-automatically” implies that the example bill-payment infrastructure 400 suggests an automated action, but it waits for confirmation from the user before performing that action.

Alternatively or additionally, the example bill-payment infrastructure 400 may be programmed to automatically (or semi-automatically) perform one or more of the following actions:
Allocate moneys from accounts in order of preference;
Select a percentage from each available funding source;
Leave a defined amount (e.g., percentage or fixed amount) in each account (e.g., balance of funds or available credit).

With these automated (or semi-automated) actions, the example bill-payment infrastructure 400 obtains information about the current balance (e.g., moneys or credit) on each account. In some instances, that may be accomplished based upon a user providing that information manually. In other instances, the example bill-payment infrastructure 400 may acquire this information directly or indirectly via an account/data access service.

For this, the user provides online account access information (e.g., username/password) for each funding source. The account/data access infrastructure automatically accesses the online accounts/sites to pull the approved data therefrom. Alternatively, the account/data access infrastructure may acquire this information via a direct and secure query of the appropriate financial institutions that host the funding sources.

### Roommate Notification

With the example bill-payment infrastructure 400, each splittee is given notifications of when their portion of a bill payment must be funded. The timing of these notifications takes into account the latency of a cascade of funding events (e.g., funding from one or more of the splittee's sources; confirmation time for ACH; funding to intermediary electronic payment services; etc.). Fellow splittees are notified when there is a funding shortage for a looming bill payment. They are given options to handle the funding shortfall situation (e.g., handle socially, provide additional funding, etc.).

The user may receive several different types of notifications. For example, one type of notification indicates that the user was added to a bill called “KDB House Rent” and the amount. It is labeled as “pending” because the user must approve this bill and his split before it becomes his obligation with the infrastructure. Another notification may tell the user that his bill labeled “Smith House Electric Bill” is due in 2 days.

The example bill-payment infrastructure 400 gives each money-transfer transaction a latency value. Some money-transfer transactions can be accomplished right way while others take several days. The moneys for a credit card transactions, for example, are transferred from the credit card company to the payee nearly immediately after the transaction or shortly thereafter. In contrast, it may take 3-4 days for moneys to be transferred with an ACH transaction. The example bill-payment infrastructure 400 takes these known latencies into account when setting due dates for a splittee to pay their portion of a bill.

In addition, these latencies may be layered because the splittee's payment may be dependent upon multiple cascading transactions. In addition, there may be a latency included for actually paying the biller. For example, it may take 2-3 days for a paper check to be delivered via the postal infrastructure.

In some instances, the example bill-payment infrastructure 400 will restrict the fund sources/transactions that the splittee can use to pay an outstanding portion of a bill because of the latency involved with particular transactions. For example, with only one day left to pay his portion of a bill, the example bill-payment infrastructure 400 will not allow Freddie to pay using ACH transaction because it requires a few days to process.

The bill owner (and/or other splittees) is notified when one of the splittees fails to fully fund their portion of a bill by the latency adjusted the due date. The bill owner (and/or other splittees) is given options to make up the difference. In such a situation, the example bill-payment infrastructure 400 sends an alert to the other splittees that notify them of the shortfall of the looming bill payment. The example bill-payment infrastructure 400 asks who, if anyone, would like to cover the shortfall. If more than one splittee agrees to cover, then each splittee pays a portion of that shortfall amount. The split of that covered portion amongst the splittee may be pro rata amongst them or consistent with their default split amongst the splittees who are participating in covering the shortfall.

The example bill-payment infrastructure 400 will track these events and factor that into future bill payments. For example, Tracy is asked to contribute $100 more to the next rent payment to make up for the $100 shortfall for the last rent payment, which was covered by Tracy's roommates.

In general, a splittee must agree to their obligation to their portion of a bill. For example, when a new bill is setup and Jon is listed as a splittee. He will receive a verification/approval request. Only after Jon has approved his splittee status and his portion will he be obligated to pay that portion of the bill. There is a splittee approval process for any new obligation or change in an existing obligation.

For example, a bill can change the splittees for the bill (e.g., more or less than all of the roommates of the household). The bill owners can change the allocation of the split for the bill. In those situations, the new splittee is asked to approve their new responsibility in the bill.

When a bill is first created, nothing is finalized yet. The bill owner assigns split allocation (e.g., 25% for each of 4 roommates). Each roommate receives a notification. It asks you to approve the details of the new responsibility of a bill. The other splittees can approve or decline their responsibility. If they all approve, then the bill is solidified. If not, then the bill owner is notified accordingly. Thus, the bill owner is likely to have to negotiate an acceptable split allocation with the declining parties.

### Shared-Responsibility Group

With the example bill-payment infrastructure 400, a group of splittees is assigned to a group called a “shared-responsibility group” or simply group. This assignment may be made manually, automatically, or semi-automatically. With this group assignment comes a set of defaults for all bills associated with the address of the household group, such as default splits.

Once the group is setup, the example bill-payment infrastructure 400 associates the group with one or more bills. Depending upon the implementation, the association may be done manually, automatically, or semi-automatically. Manually, the bill owner specifies the group when creating a new bill. In some instances, the example bill-payment infrastructure 400 automatically assigns a group based upon a match between the default information (e.g., address and splittees) and the new bill. The example bill-payment infrastructure 400 asks for the bill owner to confirm the automatic selection. This part is the semi-automatic action.

The bill owner sets up the default set within a group. There may be a default group of splittees assigned to each group bill. There may be a default split (e.g., percentage, base amount plus a percentage, fixed amounts, etc.).

### Splittee Payment Details

With the example bill-payment infrastructure 400, a set of priorities/preferences (i.e., waterfall) may be assigned for fund sources and funding transactions from which payments may be made. For example, given particular conditions (i.e., funding availability, the timing of payment, etc.), a splittee's portion of a bill payment may be pulled from particular fund sources using particular funding transaction types.

Each splittee may define a set of priorities and/or preferences for funding sources and transactions from which payments may be made. These “preference settings” are often represented as a cascade of priorities, which may be called a “waterfall.”

These preference settings may define a default for the splittee, for a group, for a biller, and/or for a bill. There may be a general setting where it specifies the order of priority of these preference settings.

Consider a preference setting for a particular splittee (named Scott). Scott may establish that when his portion of a bill is to be paid, the example bill-payment infrastructure 400 should attempt to draw moneys from particular sources using particular transactions and in a given order. This preference setting may indicate that the example bill-payment infrastructure 400 should attempt to draw all moneys from a checking account (for example) via a debit card. However, if that transaction is unsuccessful, then attempts to draw moneys from his credit card account, and so forth.

Thus, these splittee preferences may indicate how much is to be drawn for which sources using which transaction type and in what order of priority. The preferences may also indicate a change in latency (e.g., 2 extra days) should be added to the funding process. It may also specify which fund sources/transactions (e.g., sponsors) that should be used for which bills. The fund sources/transactions may be varied based upon other conditions (such as the timing of due dates).

Based upon the settings, the example bill-payment infrastructure 400 may be programmed to automatically (or semi-automatically) perform one or more of the following actions (for example):
Allocate moneys from accounts in order of preference;
Select a percentage from each available funding source;
Leave a defined amount (e.g., percentage or fixed amount) in each account (e.g., balance of funds or available credit).

With these automated (or semi-automated) actions, the example bill-payment infrastructure 400 obtains information about the current balance (e.g., moneys or credit) on each account. In some instances, that may be accomplished based upon a user providing that information manually. In other instances, the example bill-payment infrastructure 400 may acquire this information directly or indirectly via an account/data access infrastructure. The user provides online account access information (e.g., username/password) for each funding source. The account/data access infrastructure automatically accesses the online accounts/sites to pull the approved data therefrom. Alternatively, the account/data access infrastructure may acquire this information via a direct and secure query of the appropriate financial institutions that host the funding sources.

### Splittee Information for Credit Bureaus

A credit bureau is an agency that researches and collects individual credit information and sells it for a fee to creditors so they can decide on granting loans or make other financial decisions. Indeed, landlords often use such services to determine if a prospective tenant has a sufficient history of being a responsible tenant.

As noted earlier, typically only one of several roommates is visible to the landlord and thus visible to credit bureaus. The actions of the other roommates is opaque and not seen by the landlord and credit bureaus. Only the visible or primary roommate receives the credit of a history of on-time payments. Likewise, the visible or primary roommate receives the detriment of late or missing payments.

However, the non-visible roommates miss an opportunity to build a good credit history. Also, landlords are unable to track the poor payment history of the non-visible roommates.

With one or more implementations of the technology described herein, the bill-payment infrastructure interacts directly with all roommates. That includes the otherwise non-visible roommates. The infrastructure can monitor and track the payment history of all splittees. Then this history can be provided to credit bureaus.

### Example Methodological Implementations

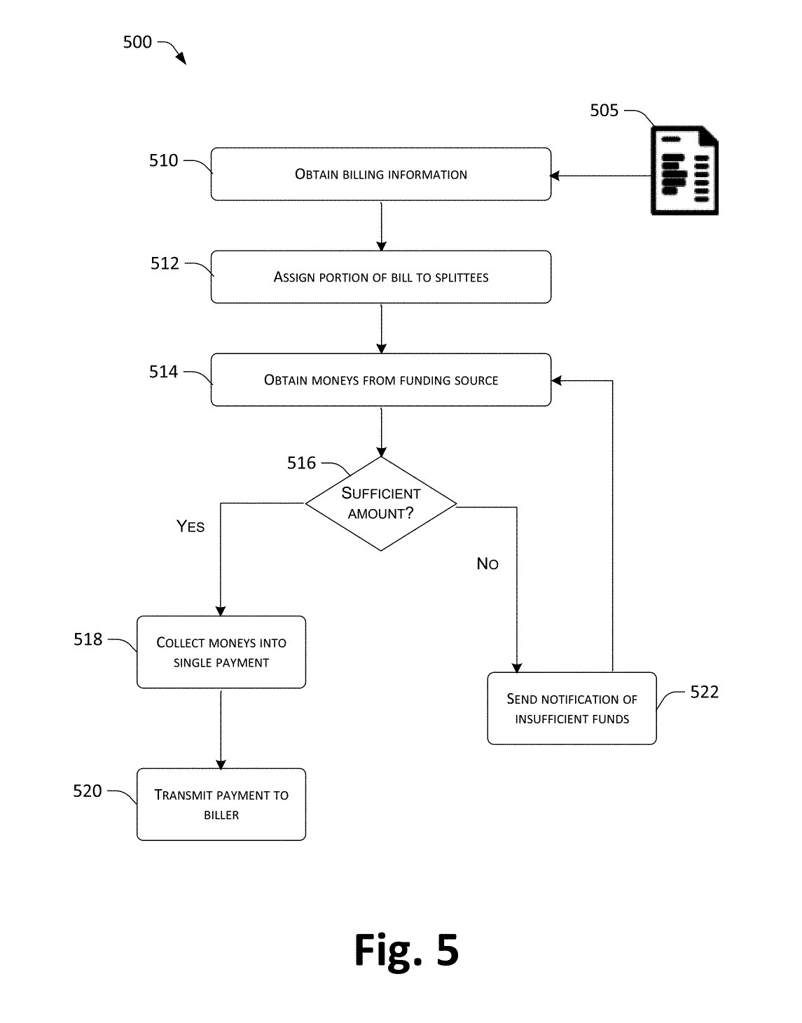

FIG. 5 shows an example process 500 illustrating the technology as described herein. The example process 500 may be implemented as part of a bill-payment infrastructure like example infrastructures 200 or 400 described herein.

At 510, a bill-paying infrastructure obtains billing information regarding a bill 505 from a biller. The billing information includes identification of the biller, the amount of the debt associated with the bill, and a date that the debt is due. A plurality (i.e., two or more) of splittees of a group share a financial obligation to pay a debt associated with the bill. For example, three roommates share responsibly for $1000 monthly payment for the lease of the house that they share.

At 512, the bill-paying infrastructure assigns a portion of the debt to each splittee. The sum of the splittee's portions is sufficient to pay the debt associated with the bill. Often, the assignment each splittee's portion is a proportional allocation of the debt.

At 514, the bill-paying infrastructure obtains moneys from a funding source of each splittee. In some implementations, with at least one of the splittees of the group, the moneys are obtained from multiple funding sources. In some instances, the funding sources differ from each other. For example, a bank checking account is a different funding source than a credit card account.

When obtaining moneys for a splittee, the funding may be acquired from a bank account, credit card account, debit card account, a line-of-credit, or other account associated with that splittee. In addition, infrastructure may automatically select a funding transaction type to obtain moneys.

In some implementations, block 514 includes receiving a user selection a funding transaction type to obtain moneys. The infrastructure obtains the due date of the bill and determines whether a latency of the selected funding transaction type exceeds the due date of the bill. If so, the splittee may be notified of that determination.

In still other implementations, block 514 includes the infrastructure obtains a due date of the bill and determines whether a latency of a funding transaction type to obtain moneys for the splittee exceeds the due date of the bill. If so, then the infrastructure enables a selection of funding transaction type other than the determined funding transaction type. That is, the splittee is not allowed to select the transaction type with the latency that exceeds the due date.

In other implementations, as part of block 514, the infrastructure may automate selection of one or more funding sources. The infrastructure acquires a prioritized listing of funding sources available for a splittee. The highest priority funding source is selected. In response to a determination that the obtained moneys for the splittee are insufficient, the infrastructure selects the next highest priority funding source on the listing from which to obtain the moneys for the obtaining moneys action.

At 516, the bill-paying infrastructure determines whether the obtained moneys for each splittee are in an amount that is sufficient to cover each splittee's assigned portion of the debt.

At 518, the bill-paying infrastructure collects the obtained moneys into a single payment that is sufficient to pay the debt associated with the if the obtained moneys for each splittee are sufficient.

At 520, the bill-paying infrastructure transmits the single payment to the biller. In some instances, the payment is issued as a paper check and delivered to the biller via a postal or delivery service. In other instances, the payment is sent by electronic transfer to the biller.

At 522, the infrastructure sends a notification that indicates the determination the obtained moneys for one or more of the splittees are insufficient. The splittee provides additional information and/or instructions to obtain moneys from other funding sources.

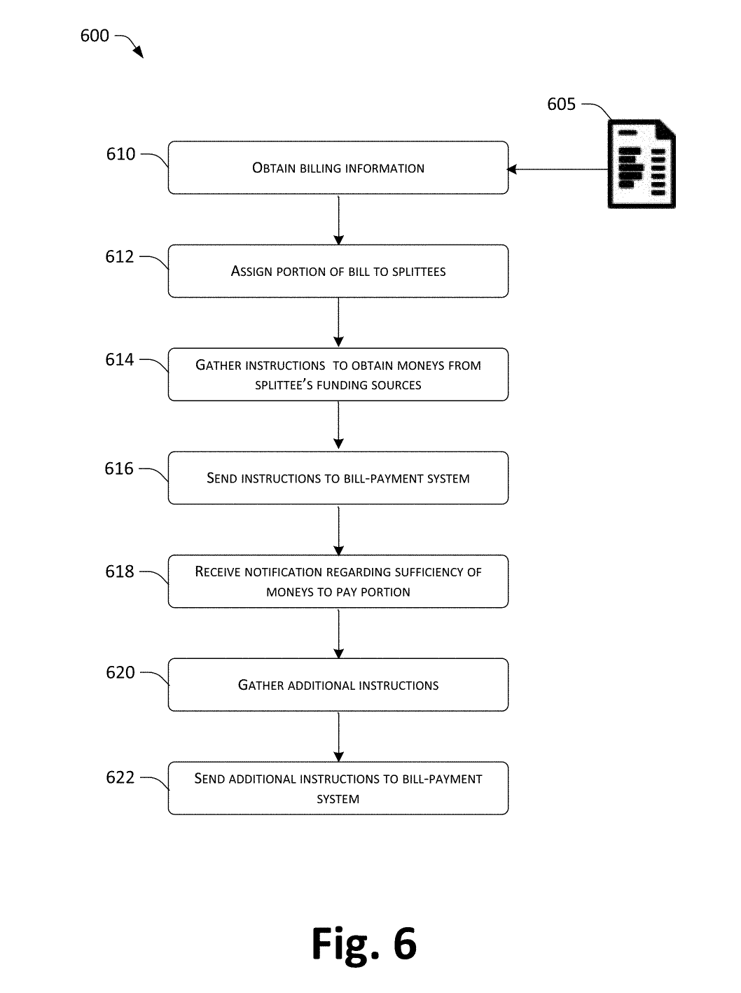

FIG. 6 shows an example process 600 illustrating the technology as described herein. The example process 600 may be implemented as a client-side device of the bill-payment infrastructure like example infrastructures 200 or 400 described herein. For example, the client-side of website or mobile application on a computer or mobile device may be used to implement this portion of the process 600.

At 610, a client-side device obtains billing information regarding a bill 605 from a biller. The billing information includes identification of the biller, the amount of the debt associated with the bill, and a date that the debt is due. A plurality (i.e., two or more)

At 612, the client-side device assigns a portion of the debt to each splittee. The sum of the splittee's portions is sufficient to pay the debt associated with the bill. Often, the assignment each splittee's portion is a proportional allocation of the debt.

At 614, the client-side device gathers instructions from the splittees regarding how to obtain their moneys from one or more of their funding sources.

At 616, the client-side device sends the gathered instructions to a bill payment system.

At 618, the client-side device receives a notification regarding whether the obtained moneys of a splittee are in an amount that is sufficient to cover that splittee's assigned portion of the debt.

At 620, in response to a notification that the obtained moneys are insufficient, the client-side device gathers additional instructions regarding how to obtain additional moneys from one or more of funding sources.

At 622, the client-side device sends the gathered additional instructions to a bill payment system.

### Additional and Alternative Implementation Details

Of course, anyone implementing the technologies described herein must comply with all rules and regulations of the banking and financial industries at the local, state, and federal level. If the implementation of the technologies described herein require a necessary license/certification from an appropriate government body, then any entity that implements such an implementation either will acquire the necessary license/certification or will partner with some other entity that has the necessary license/certification.

Reference herein to “one embodiment” or “an embodiment” refers to one or more features, structures, materials, or characteristics described at least one example embodiment of the technology described herein. It does not denote or imply that the features, structures, materials, or characteristics are present in every embodiment. Thus, the appearances of the phrases “in one embodiment” or “in an embodiment” in various places throughout this document are not necessarily referring to the same embodiment of the technology. Furthermore, the features, structures, materials, or characteristics may be combined in any suitable manner in one or more embodiments.

In the above description of example implementations, for purposes of explanation, specific numbers, materials configurations, and other details are set forth to explain better the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques,” for instance, may refer to one or more devices, apparatuses, infrastructure, methods, articles of manufacture, and computer-readable instructions as indicated by the context described herein.

As used in this application, the term “or” is intended to mean an inclusive “or” rather than an exclusive “or.” That is unless specified otherwise or clear from context, “X employs A or B” is intended to mean any of the natural inclusive permutations. That is if X employs A; X employs B; or X employs both A and B, then “X employs A or B” is satisfied under any of the preceding instances. Also, the articles “an” and “an” as used in this application and the appended claims should be construed to mean “one or more,” unless specified otherwise or clear from context to be directed to a singular form.

These processes are illustrated as a collection of blocks in a logical flow graph, which represents a sequence of operations that can be implemented in mechanics alone or a combination of hardware, software, and firmware. In the context of software/firmware, the blocks represent instructions stored on one or more computer-readable storage media that, when executed by one or more processors, perform the recited operations.

Note that the order in which the processes are described is not intended to be construed as a limitation and any number of the described process blocks can be combined in any order to implement the processes or an alternate process. Additionally, individual blocks may be deleted from the processes without departing from the spirit and scope of the subject matter described herein.

The term “computer-readable media” is non-transitory computer-storage media. For example, non-transitory computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)). Similarly, the term “machine-readable media” is non-transitory machine-storage media. Likewise, the term “processor-readable media” is non-transitory processor-storage media.

A non-transitory machine-readable storage medium can cause a machine to perform the functions or operations described, and includes any mechanism that stores information in a form accessible by a machine (e.g., computing device, electronic infrastructure, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface is configured by providing configuration parameters or sending signals to prepare the communication interface to provide a data signal describing the software content. The communication interface can be accessed via one or more commands or signals sent to the communication interface.

In the claims appended herein, the inventors invoke 35 U.S.C. §112(f) only when the words “means for” or “steps for” are used in the claim. If such words are not used in a claim, then the inventors do not intend for the claim to be construed to cover the corresponding structure, material, or acts described herein (and equivalents thereof) in accordance with 35 U.S.C. 112(f).

A non-transitory machine-readable storage medium can cause a machine to perform the functions or operations described, and includes any mechanism that stores information in a form accessible by a machine (e.g., computing device, electronic infrastructure, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface is configured by providing configuration parameters or sending signals to prepare the communication interface to provide a data signal describing the software content. The communication interface can be accessed via one or more commands or signals sent to the communication interface.

In the alternative, embodiments described herein and/or other embodiments may also be described in accordance with the examples below:

### EXAMPLE 1

A method that facilitates payment of bills or computer-readable medium with instructions directing operations that perform the method. The method of Example 1 includes obtaining billing information regarding a bill from a biller, wherein a plurality of splittees of a group share an obligation to pay a debt associated with the bill; assigning a portion of the debt to each splittee, wherein a sum of the splittee's portions is sufficient to pay the debt associated with the bill; obtaining moneys from a funding source of each splittee; determining whether the obtained moneys for each splittee are in an amount that is sufficient to cover each splittee's assigned portion of the debt; in response to a determination that the obtained moneys for each splittee are sufficient, collecting the obtained moneys into a single payment that is sufficient to pay the debt associated with the bill; transmitting the single payment to the biller.

### EXAMPLE 2

A method or computer-readable medium as recited in example 1, wherein the billing information includes identification of the biller, amount of the debt associated with the bill, and a date that the debt is due.

### EXAMPLE 3

A method or computer-readable medium as recited in example 1, wherein the assigning each splittee's portion includes a proportional allocation of the debt.

### EXAMPLE 4

A method or computer-readable medium as recited in example 1, wherein the obtaining moneys for a particular splittee includes acquiring funding from a bank account associated with that particular splittee.

### EXAMPLE 5

A method or computer-readable medium as recited in example 1, wherein the obtaining moneys for a particular splittee includes acquiring funding from a credit card or debit card associated with that particular splittee.

### EXAMPLE 6

A method or computer-readable medium as recited in example 1 further comprising selecting a funding transaction type to obtain moneys for a particular splittee.

### EXAMPLE 7

A method or computer-readable medium as recited in example 1 further comprising selecting a funding transaction type to obtain moneys for a particular splittee, wherein the particular splittee specifies that selected funding transaction type.

### EXAMPLE 8

A method or computer-readable medium as recited in example 1 further comprising: selecting a funding transaction type to obtain moneys for a particular splittee, wherein the particular splittee specifies that selected funding transaction type; obtaining a due date of the bill; determining that a latency of the selected funding transaction type exceeds the due date of the bill; in response to the determination that the latency of the selected funding transaction type exceeds the due date of the bill, notifying the particular splittee of that determination.

### EXAMPLE 9

A method or computer-readable medium as recited in example 1 further comprising: obtaining a due date of the bill; determining that a latency of a funding transaction type to obtain moneys for a particular splittee exceeds the due date of the bill; enabling a selection of funding transaction type other than the determined funding transaction type.

### EXAMPLE 10

A method or computer-readable medium as recited in example 1 further comprising, in response to a determination that the obtained moneys for each splittee are insufficient, sending a notification that indicates that determination.

### EXAMPLE 11

A method or computer-readable medium as recited in example 1 further comprising, in response to a determination that the obtained moneys for one of the splittees are insufficient, sending a notification that indicates that determination the splittee with insufficient funding.

### EXAMPLE 12

A method or computer-readable medium as recited in example 1 further comprising, for a particular splittee: acquiring a prioritized listing of funding sources available for the particular splittee; selecting a highest priority funding source on the listing from which to obtain the moneys for the obtaining moneys action; in response to a determination that the obtained moneys for the particular splittee are insufficient, selecting a next highest priority funding source on the listing from which to obtain the moneys for the obtaining moneys action.

### EXAMPLE 13

A method or computer-readable medium as recited in example 1 further comprising, with at least one of the splittees of the group, obtaining moneys from multiple funding sources.

### EXAMPLE 14

A method or computer-readable medium as recited in example 1 further comprising, with at least one of the splittees of the group, obtaining moneys from multiple differing funding sources.

### EXAMPLE 15

A method or computer-readable medium as recited in example 1, wherein the transmitting includes issuing of a paper check and delivery of that check to the biller via a postal or delivery service.

### EXAMPLE 16

A method or computer-readable medium as recited in example 1, wherein the transmitting includes electronic transfer of funds to the biller.

### EXAMPLE 17

A method or computer-readable medium as recited in example 1, wherein the assigning the portions includes: sending a notification to the splittees regarding their assigned portion; receiving an approval from the splittees regarding their assigned portion.

### EXAMPLE 18

A method or computer-readable medium as recited in example 1, wherein the assigning the portions includes calculating portions based upon one or more conditions.

What is claimed is:

1. A method that facilitates payment of bills, the method comprising:
obtaining billing information regarding a bill from a biller, wherein a plurality of splittees of a group share an obligation to pay a debt associated with the bill;
assigning a portion of the debt to each splittee, wherein a sum of the splittee's portions is sufficient to pay the debt associated with the bill;
obtaining moneys from a funding source of each splittee;
determining whether the obtained moneys for each splittee are in an amount that is sufficient to cover each splittee's assigned portion of the debt;
in response to a determination that the obtained moneys for each splittee are sufficient, collecting the obtained moneys into a single payment that is sufficient to pay the debt associated with the bill;
transmitting the single payment to the biller.

2. A method as recited in claim 1 further comprising:
selecting a funding transaction type to obtain moneys for a particular splittee, wherein the particular splittee specifies that selected funding transaction type;
obtaining a due date of the bill;
determining that a latency of the selected funding transaction type exceeds the due date of the bill;
in response to the determination that the latency of the selected funding transaction type exceeds the due date of the bill, notifying the particular splittee of that determination.

3. A method as recited in claim 1 further comprising:
obtaining a due date of the bill;
determining that a latency of a funding transaction type to obtain moneys for a particular splittee exceeds the due date of the bill;
enabling a selection of funding transaction type other than the determined funding transaction type.

4. A method as recited in claim 1 further comprising, in response to a determination that the obtained moneys for one of the splittees are insufficient, sending a notification that indicates that determination the splittee with insufficient funding.

5. A method as recited in claim 1 further comprising, for a particular splittee:
acquiring a prioritized listing of funding sources available for the particular splittee;
selecting a highest priority funding source on the listing from which to obtain the moneys for the obtaining moneys action;
in response to a determination that the obtained moneys for the particular splittee are insufficient, selecting a next highest priority funding source on the listing from which to obtain the moneys for the obtaining moneys action.

6. A method as recited in claim 1 further comprising, with at least one of the splittees of the group, obtaining moneys from multiple funding sources.

7. A method as recited in claim 1 further comprising, with at least one of the splittees of the group, obtaining moneys from multiple differing funding sources.

8. A method as recited in claim 1, wherein the assigning the portions includes:
sending a notification to the splittees regarding their assigned portion;
receiving an approval from the splittees regarding their assigned portion.

9. One or more computer-readable media storing instructions thereon that, when executed by one or more processors, direct the one or more processors to perform operations that facilitate a bill payment system, the operations comprising:
obtaining billing information regarding a bill from a biller, wherein a plurality of splittees of a group share an obligation to pay a debt associated with the bill, wherein the billing information includes identification of the biller, amount of the debt associated with the bill, and a date that the debt is due;
assigning a portion of the debt to each splittee, wherein a sum of the splittee's portions is sufficient to pay the debt associated with the bill;
obtaining moneys from a funding source of each splittee, wherein moneys of at least one of the splittees are obtained from multiple funding sources;
determining whether the obtained moneys for each splittee are in an amount that is sufficient to cover each splittee's assigned portion of the debt;
in response to a determination that the obtained moneys for each splittee are sufficient, collecting the obtained moneys into a single payment that is sufficient to pay the debt associated with the bill;
transmitting the single payment to the biller.

10. One or more computer-readable media as recited in claim 9, wherein the assigning each splittee's portion includes a proportional allocation of the debt.

11. One or more computer-readable media as recited in claim 9, wherein the obtaining moneys for a particular splittee includes acquiring funding from a bank account associated with that particular splittee.

12. One or more computer-readable media as recited in claim 9, wherein the obtaining moneys for a particular splittee includes acquiring funding from a credit card or debit card associated with that particular splittee.

13. One or more computer-readable media as recited in claim 9, wherein the operations further comprise selecting a funding transaction type to obtain moneys for a particular splittee.

14. One or more computer-readable media as recited in claim 9, wherein the operations further comprise, for a particular splittee:
acquiring a prioritized listing of funding sources available for the particular splittee;
selecting a highest priority funding source on the listing from which to obtain the moneys for the obtaining moneys action;
in response to a determination that the obtained moneys for the particular splittee are insufficient, selecting a next highest priority funding source on the listing from which to obtain the moneys for the obtaining moneys action.

15. One or more computer-readable media storing instructions thereon that, when executed by one or more processors, direct the one or more processors to perform operations that facilitate a payment of bills, the operations comprising:
obtaining billing information regarding a bill from a biller, wherein a plurality of splittees of a group share an obligation to pay a debt associated with the bill, wherein the billing information includes identification of the biller, amount of the debt associated with the bill, and a date that the debt is due;
assigning a portion of the debt to each splittee, wherein a sum of the splittee's portions is sufficient to pay the debt associated with the bill;
gathering instructions from each splittee regarding how to obtain their moneys from one or more of their funding sources;
sending the gathered instructions to a bill payment system;
receiving a notification regarding whether the obtained moneys of a splittee are in an amount that is sufficient to cover that splittee's assigned portion of the debt;
in response to a notification that the obtained moneys are insufficient, gathering additional instructions regarding how to obtain additional moneys from one or more of funding sources;
sending the gathered additional instructions to a bill payment system.

16. One or more computer-readable media as recited in claim 15, wherein the assigning each splittee's portion includes a proportional allocation of the debt.

17. One or more computer-readable media as recited in claim 15, wherein the operations further comprise selecting a funding transaction type to obtain moneys for a particular splittee, wherein the particular splittee specifies that selected funding transaction type.

18. One or more computer-readable media as recited in claim 15, wherein the operations further comprise:
selecting a funding transaction type to obtain moneys for a particular splittee, wherein the particular splittee specifies that selected funding transaction type;
obtaining a due date of the bill;
determining that a latency of the selected funding transaction type exceeds the due date of the bill;
in response to the determination that the latency of the selected funding transaction type exceeds the due date of the bill, notifying the particular splittee of that determination.

19. One or more computer-readable media as recited in claim 15, wherein the operations further comprise:
obtaining a due date of the bill;
determining that a latency of a funding transaction type to obtain moneys for a particular splittee exceeds the due date of the bill;
enabling a selection of funding transaction type other than the determined funding transaction type.

20. One or more computer-readable media as recited in claim 15, wherein the assigning the portions includes:
receiving a notification regarding a splittee's assigned portion;
sending an approval from the splittee regarding their assigned portion.
